(19) United States
(12) Patent Application Publication
(10) Pub. No.: US 2005/0018291 A1
(43) Pub. Date: Jan. 27, 2005

(54) Side view mirror assembly wit quiet drain feature

(76) Inventor: Nick Rigney, Royal Oak, MI (US)

Correspondence Address: Thomas E Donohue;Artz & Artz, 28333 Telegraph Road, Suite 250, Southfield, MI, 48034, US

(21) Appl. No.: 10/484,641

(22) PCT Filed: Jul. 23, 2002
(86) PCT No.: PCT/US02/23370

Related U.S. Application Data
(60) Provisional application No. 60/307,246, filed on Jul. 23, 2001.

(51) Int. Cl. G02B 1/00

(52) U.S. Cl. 359/507; 359/838

(57) ABSTRACT

A vehicle mounted mirror assembly (10) is provided, including a housing (14), a drain hole (16), and an air flow disruption member (18) positioned upwind of the drain hole (16) creating turbulence in the air passing over the drain hole (16) and thereby reducing wind noise.

### TECHNICAL FIELD

The present invention relates generally to an automotive side view mirror and more particularly to an automotive side view mirror assembly with a quiet drain feature.

### BACKGROUND OF THE INVENTION

The design of automotive components is often dictated by a wide variety of design considerations. Often, it is not sufficient that an automotive component simply perform its intended function. Instead, modern automotive components must be designed with a variety of factors in mind. These design considerations include, but are not limited to, cost, weight, efficiency, style, manufacturing simplicity, vibrational characteristics, and noise characteristics. A successful design is often one that optimizes these design characteristics while still accomplishing the component's primary function.

Such is the case with automotive components mounted on the exterior of the vehicle. One of these components is the automotive side view mirror. The primary function of automotive side view mirrors is to increase the driver's visual field while allowing-him to concentrate on the road ahead. When designing automotive side view mirrors, however, a host of secondary design considerations must often be incorporated. Reductions in cost, manufacturing complexity, and weight are beneficial. Structural strength and style must also be considered. One area of design that should not be overlooked is the reduction of wind noise.

Advancements in the design of automotive side view mirrors have lead to aerodynamic shapes that reduce the amount of wind noise generated. Although the aerodynamic shapes have reduced the level of wind noise generated, there is still room for further improvement. For example, often small drainage holes are formed in the mirror housing to allow condensation or other water accumulation to drain from the mirror assembly. These drain holes, while highly effective, often catch the wind as it passes by the mirror assembly and lead to unacceptable noise generation.

It is known that by placing these holes on a surface, angled away from the oncoming wind, wind noise generation may be effectively reduced. This solution, however, can require adjusting the design of the side view mirror housing to accommodate such hole placement. Thus it is possible for the use of a drainage hole to reduce the flexibility of the mirror housing design. It may be more desirable to have the shape of the side view mirror housing dictated by design and style considerations rather than by the necessity of having a non-planar drainage hole. In addition, it is possible for such alterations in housing design to increase the cost and time of mirror production.

It would, therefore, be highly desirable to have a side-view mirror assembly, including a drainage hole, which provided increased flexibility in design while reducing wind noise generation. It would additionally be desirable to have such a low wind noise drain hole that could be inexpensively incorporated into known side view mirror designs at a low cost and without the necessity of significantly altering present aerodynamic or style-based shapes.

### SUMMARY OF THE INVENTION

It is, therefore, an object of the present invention to provide a side view mirror assembly with a low wind noise generating drain hole. It is a further object of the present invention to provide such a side view mirror assembly with a low wind noise drain hole with increased flexibility for side view mirror styling.

In accordance with the objects of the present invention, a vehicle mounted mirror assembly is provided. The vehicle mounted mirror assembly includes a housing. A drain hole is positioned within the housing to allow water trapped within the housing to exit the vehicle mounted mirror assembly. An air flow disruption member is positioned upwind of the drain hole, creating turbulence in air passing over the drain hole and thereby reducing wind noise.

Other objects and features of the present invention will become apparent when viewed in light of the detailed description of the preferred embodiment when taken in conjunction with the attached drawings and appended claims.

### BRIEF DESCRIPTION OF THE DRAWINGS

FIG. 1 is an illustration of an embodiment of a vehicle mounted mirror assembly in accordance with the present invention;

FIG. 2 is a bottom view detail of a vehicle mounted mirror assembly as shown in FIG. 1;

FIG. 3 is a detail of an embodiment of a portion of a vehicle mounted mirror assembly in accordance with the present invention, the detail illustrating an embodiment of the air disruption element;

FIG. 4 is a cross-sectional illustration of the detail illustration in FIG. 3, the cross-section taken along the line 4-4 in the directions of the arrows;

FIG. 5 is a detail of an embodiment of a vehicle mounted mirror assembly in accordance with the present invention, the detail illustrating an embodiment of an air disruption element;

FIG. 6 is a cross-sectional illustration of the detail illustrated in FIG. 5, the cross-section taken along the line 6-6 in the direction of the arrows;

FIG. 7 is detail of an embodiment of a vehicle mounted mirror assembly in accordance with the present invention, the detail illustrating an embodiment of an air disruption element; and

FIG. 8 is a cross-sectional illustration of the detail illustrated in FIG. 8, the cross-section taken along the line 8-8 in the direction of the arrows.

### DESCRIPTION OF THE PREFERRED EMBODIMENT(S)

Referring now to FIG. 1 which is an illustration of an embodiment of a vehicle mounted mirror assembly 10 in accordance with the present invention. The vehicle mounted mirror assembly 10 is show in communication with an automobile 12. Although a particular shape and style of both vehicle mounted mirror assembly 10 and automobile 12 are illustrated, it should be understood that a wide variety of shapes and configurations of vehicle mounted mirror assemblies 10 and automobiles 12 are known in the prior art and contemplated by the present invention.

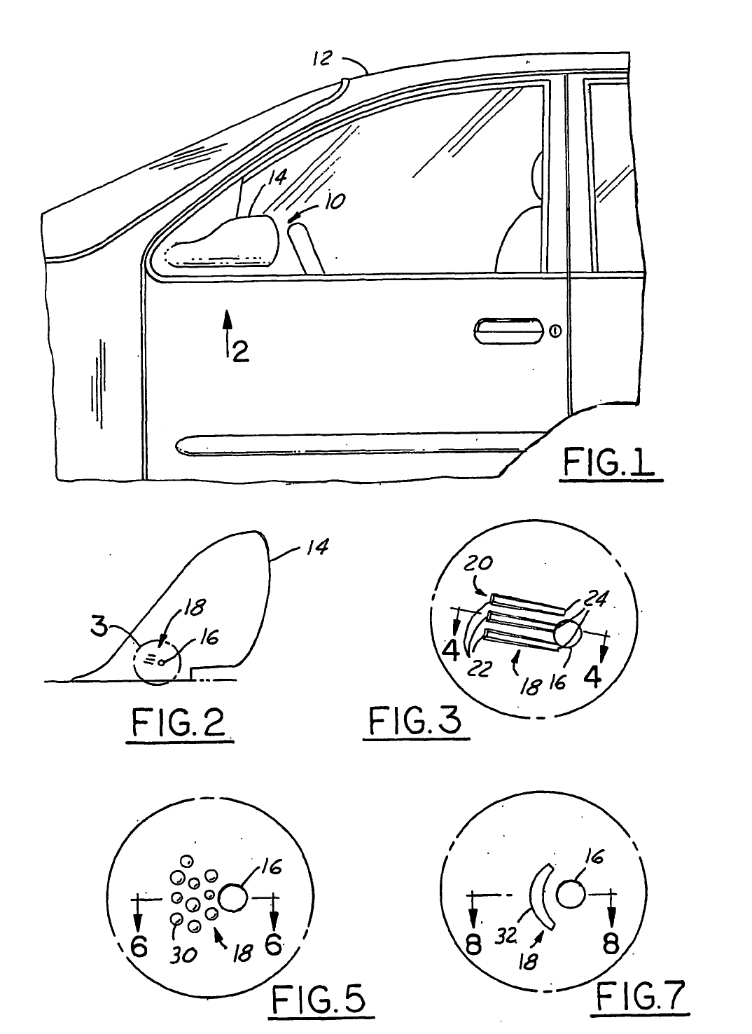

Referring now to FIG. 2, which is an illustration of a bottom view of a vehicle mounted mirror assembly 10 in accordance with the present invention. The vehicle mounted mirror assembly 10 includes a housing 14. A drain hole 16 is positioned within the housing 14 to allow water or other fluids trapped within the vehicle mounted mirror assembly 10 to drain out from the housing 14. The use of drain holes 16 is well-known in the prior art. The present invention, however, further includes an air disruption element 18 positioned upwind of the drain hole 16. The air disruption member 18 creates turbulence in the air passing over the drain hole 16. By creating turbulence, the air flow disruption member 18 reduces the generation of wind noise often created by wind passing over the drain hole 16.

Although prior art designs have reduced drain hole wind noise by positioning the drain hole 16 on a surface angled so as not to catch the wind, the present invention through the use of an air disruption element 18 provides greater flexibility in drain hole 16 placement. The drain hole 16 in the present invention may be positioned in a wide variety of locations on the mirror housing 14 while still retaining the benefit of reduced wind noise. In this way, fewer constraints are placed on the styling, configuration, and manufacturing technique used to create the vehicle mounted mirror assembly. In addition, manufacturing costs may be minimized due to the simplicity with which the present invention may be incorporated to present designs.

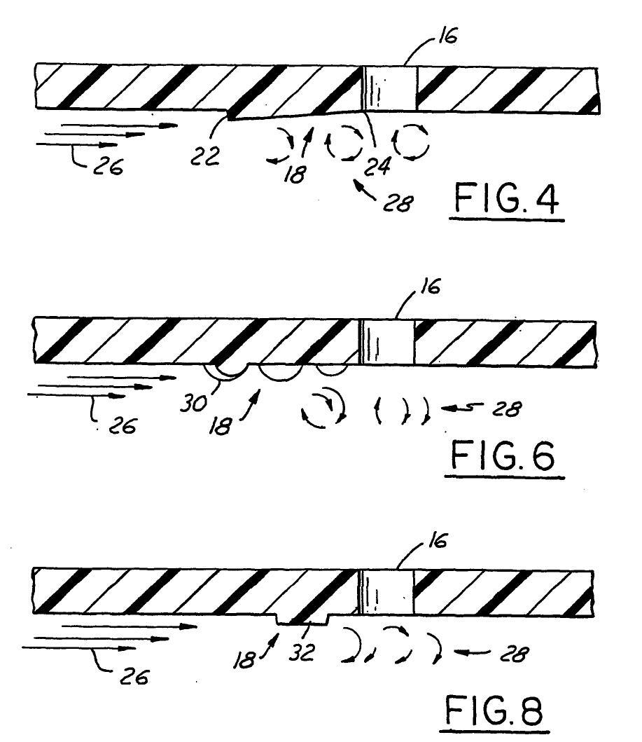

Referring now to FIG. 3, which is a detail of the vehicle mounted mirror assembly 10 in accordance with the present invention, the detail illustrating one embodiment of the air disruption member 18. In this embodiment, the air disruption member 18 includes a plurality of wedge members 20. The wedge members 20 have an elevated leading edge 22 that blend to a flat trailing edge 24 (see FIG. 4). The wedge members 20, preferably placed in a localized area immediately upwind of the drain hole 16, cause turbulence 26 in the air as it passes over the drain hole 16 and have been found to reduce the generation of wind noise. It should be understood that although a plurality of wedge elements 20 have been illustrated and described, it is contemplated that the air disruption member 18 may consist of only a single wedge element 20.

It is contemplated that the air disruption member 16, in alternate embodiments, may be formed in a wide variety of shapes and configurations in order to induce turbulence and air passing over the drain hole 16. One alternate embodiment includes dimple members 28 (see FIGS. 5 and 6). Another embodiment utilizes a simple geometric shape 30 with a raised face 32 positioned upwind of the drain hole 16 (see FIGS. 7 and 8). Although several configurations for an air disruption element 18 have been illustrated and described, it should be understood that a vast number of shapes and sizes of air disruption elements 18 may be utilized to induce turbulence in the air as it passes over the drain hole 16.

In addition to the wide array of configurations that air disruption member 18 may embody, the air disruption member 18 may additionally be formed through a wide variety of methods. In one embodiment, it is contemplated that the air disruption member 18 may be molded integrally with the mirror housing 14. This provides a quick, inexpensive and reliable method of forming the air disruption member 18 especially when the housing 14 is formed using injection molding techniques. In other embodiments, however, the air disruption member 18 may be formed by stamping, as a separate attached element, or through any well-known manufacturing technique. The flexibility of manufacturing techniques along with the flexibility and reduced cost associated with drain hole 16 creates a robust and cost effective side-view mirror assembly 10.

While particular embodiments of the invention have been shown and described, numerous variations and alternative embodiments will occur to those skilled in the art. Accordingly, it is intended that the invention be limited only in terms of the appended claims.

1. A vehicle mounted mirror assembly comprising:
a housing;
a drain hole positioned within said housing allowing water trapped within said housing to exit the vehicle mounted mirror assembly; and
an air flow disruption member positioned upwind of said drain hole, said air flow disruption member creating turbulence in air passing over said drain hole and thereby reducing wind noise.

2. A vehicle mounted mirror assembly as described in claim 1 wherein said air flow disruption member includes a wedge element.

3. A vehicle mounted mirror assembly as described in claim 1 wherein said air flow disruption member includes a dimple element.

4. A vehicle mounted mirror assembly as described in claim 1 wherein said air flow disruption member includes a simple geometric shape.

5. A vehicle mounted mirror assembly as described in claim 1 wherein said air flow disruption member is formed integrally with said housing.

6. A vehicle mounted mirror assembly as described in claim 1 wherein said air flow disruption member is formed on said housing through an injection molded process.

7. A vehicle mounted mirror assembly as described in claim 1 wherein said air flow disruption member is formed on said housing through a stamping process.

8. A vehicle mounted mirror assembly as described in claim 1 wherein said air flow disruption member is formed as a separate element and affixed to said housing.

9. A method of reducing wind noise generated by a drain hole formed within the housing of a vehicle mounted mirror assembly comprising:
creating turbulence in the air upwind of the drain hole.

10. A method as described in claim 9 wherein said creating turbulence is performed in a localized area immediately upwind of the drain hole.

11. A method as described in claim 9 wherein said creating turbulence in the air is accomplished through the use of a wedge-shaped element.

12. A method as described in claim 9 wherein said creating turbulence in the air is accomplished through the use of a dimple-shaped element.

13. A method as described in claim 9 wherein said creating turbulence in the air is accomplished through the use of a simple geometrically-shaped element.

14. A method as described in claim 9 wherein said creating turbulence is accomplished through the use of a plurality of air flow disruption elements positioned immediately upwind of the drain hole.
